(19) United States
(12) Patent Application Publication
(10) Pub. No.: US 2008/0279646 A1
(43) Pub. Date: Nov. 13, 2008

(54) Core Cutter

(75) Inventor: Masaaki Miyanaga, Hyogo (JP)

Correspondence Address: MARSHALL, GERSTEIN & BORUN LLP, 233 S. WACKER DRIVE, SUITE 6300, SEARS TOWER, CHICAGO, IL, 60606, US

(73) Assignee: KABUSHIKI KAISHA MIYANAGA, Hyogo (JP)

(21) Appl. No.: 11/573,853

(22) PCT Filed: Aug. 23, 2005
(86) PCT No.: PCT/JP2005/015281

§ 371 Date: Sep. 17, 2007

(30) Foreign Application Priority Data
Aug. 31, 2004 (JP) 2004-252091

(51) Int. Cl. B23B 51/04

(52) U.S. Cl. 408/204

(57) ABSTRACT

A core cutter that enables debris generated by cutting from inside of the core cutter to be easily discharged therefrom is disclosed. A core cutter comprising a core body 4; cutting chips 1 arranged to be suitably spaced apart from each other in a circumferential direction thereof on a tip end of the core body 4 and a shank portion 2 provided at a base end of the core body 4; wherein a plurality of cutting chips 1A, 1B, and 1C arranged adjacent each other in the circumferential direction, which are included in the cutting chips 1 arranged to be suitably spaced apart from each other, protrude radially inward farther than cutting chips 1D, 1E, and 1F other than the plurality of cutting chips arranged adjacent each other.

### TECHNICAL FIELD

The present invention relates to a core cutter capable of drilling holes in materials such as metal material, stone material, wood material, composite material, etc.

### BACKGROUND ART

Conventionally, a core cutter has been used to cut materials, such as steel (see patent document 1).

In this core cutter, since its outer peripheral portion performs cutting in contrast to general drill for drilling holes, the hole can be drilled more efficiently and with smaller rotational torque and the peripheral edge region of a thin plate is cut properly in contrast to the general drill.

Patent Document 1: Japanese Laid-Open Patent Application Publication No. Hei. 11-129110

### DISCLOSURE OF THE INVENTION

### Problems to be Solved by the Invention

However, after drilling holes, cylindrical debris remain inside a core body of the core cutter, and it is in some cases extremely difficult to remove these debris therefrom.

The present invention has been made under the circumstances, and an object of the present invention is to provide a core cutter that is capable of easily discharging from inside the core cutter, debris generated by cutting operation of the core cutter.

### Means for Solving the Problems

The object of the present invention is achieved by the core cutter having a construction described below.

A core cutter of the present invention comprises a core body; cutting chips arranged to be suitably spaced apart from each other in a circumferential direction thereof on a tip end of the core body and a shank portion provided at a base end of the core body; wherein a plurality of cutting chips arranged adjacent each other in the circumferential direction, which are included in the cutting chips arranged to be suitably spaced apart from each other, protrude radially inward farther than cutting chips other than the plurality of cutting chips arranged adjacent each other.

It is preferable that in the core cutter, the plurality of cutting chips arranged adjacent each other in the circumferential direction may be arranged in a substantially half region of the core body in the circumferential direction. Thereby, the core cutter is able to carry out cutting stably.

In the core cutter, each of the cutting chips may be structured in such a manner that an inner diameter end of a rear end portion in a rotational direction of the core cutter is located radially outward relative to an inner diameter end of a front end portion in the rotational direction, and an outer diameter end of the rear end portion is located radially inward relative to an outer diameter end of the front end portion. Thereby, during cutting being performed by the cutting chip, cutting resistance at the cutting chip is reduced and smooth cutting is achieved in addition to the above mentioned advantage.

In the cote cutter, the plurality of cutting chips arranged to be suitably spaced apart from each other in the circumferential direction may be unequally spaced apart from each other. This makes it possible to reduce a chatter vibration during drilling holes and to carry out smooth cutting.

In the core cutter, a protruding length of the cutting chip that protrudes downward from the core body may be set to a predetermined value or more. Thereby, undesirably deep cutting of the core cutter into the material can be inhibited. As a result, the core cutter is able to carry out smooth cutting.

### EFFECTS OF THE INVENTION

In accordance with the core cutter of the present invention constructed above, since there is a sufficient gap between the inner periphery of the core body of the core cutter and the debris generated by cutting, the debris can be easily separated from the core cutter because of the sufficient gap between the core cutter and the debris. As a result, the debris can be discharged easily from the inside of the core cutter.

### BRIEF DESCRIPTION OF THE DRAWINGS

FIG. 1 is a bottom view showing a construction relating to arrangement of cutting chips of a core cutter according to an embodiment of the present invention;

FIG. 2A is a bottom view showing a gap between debris generated by cutting by the core cutter of FIG. 1 and an inner diameter end of a core body of the core cutter;

FIG. 2B is a bottom view showing a gap between debris generated by cutting by the conventional core cutter and an inner diameter end of a core body of the core cutter;

FIG. 3 is a partial enlarged bottom view showing a region including cutting chips disposed to protrude radially inward in the core cutter of FIG. 1;

FIG. 4 is a side view showing a construction of the core cutter of FIG. 1;

FIG. 5 is a bottom view showing arrangement of unequally spaced cutting chips of the core cutter of FIG. 1; and

FIG. 6 is a bottom view of a core cutter showing arrangement of unequally spaced cutting chips of a core cutter according to an embodiment different from that of FIG. 5.

### EXPLANATION OF REFERENCE NUMBERS

1 Cutting chip
1A, 1B, 1C plural adjacent cutting chips
1D, 1E, 1F other cutting chips
2 shank portion
3 core body
A core cutter

### BEST MODE FOR CARRYING OUT THE INVENTION

Now, embodiments of a core cutter of the present invention will be described with reference to the drawings.

### Embodiment 1

Hereinafter, a core cutter according to embodiments of the present invention will be described with reference to the drawings.

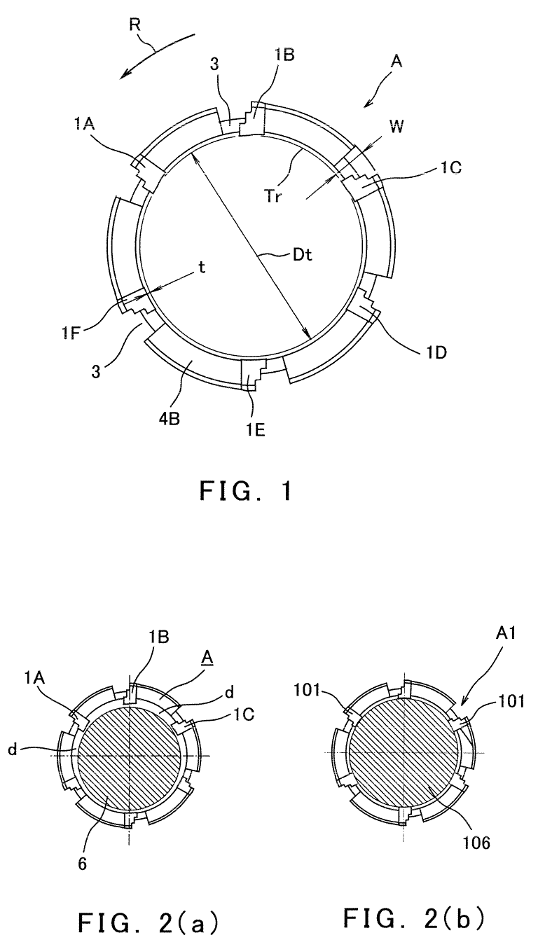

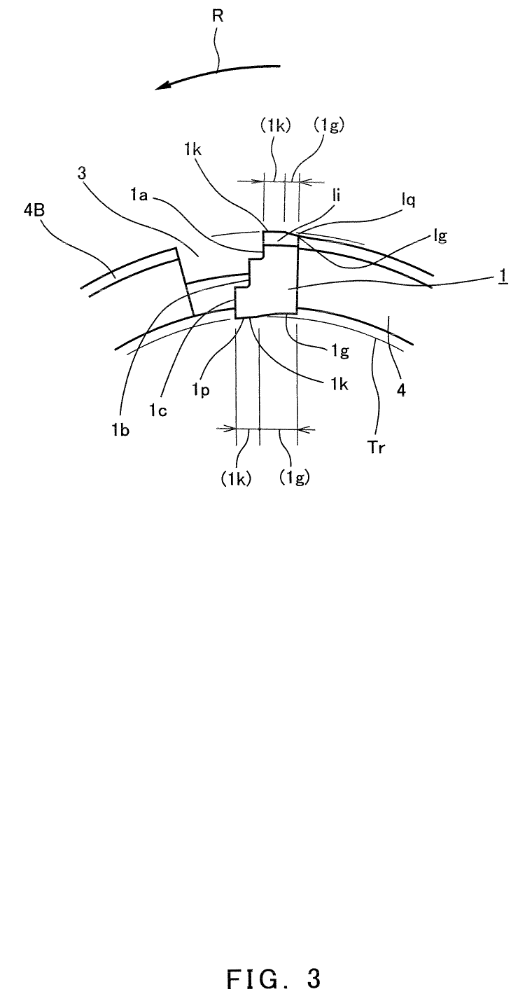

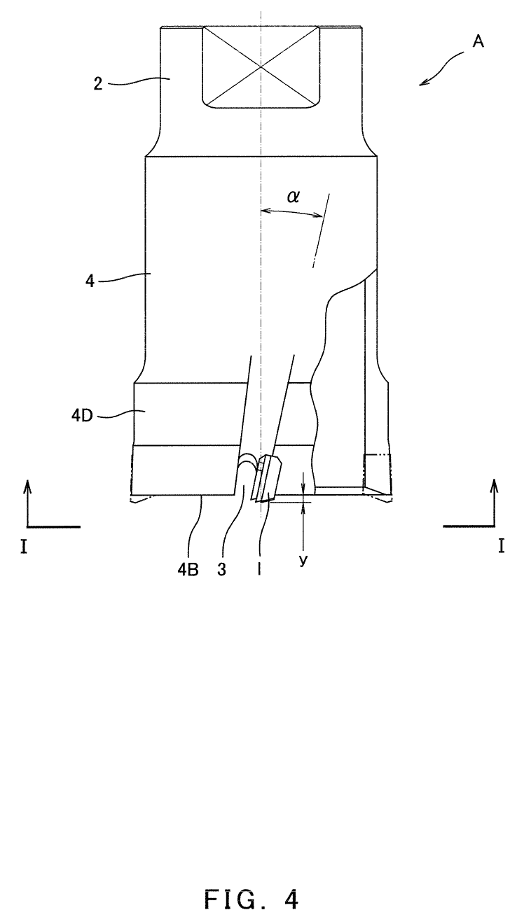

Referring to FIG. 4, A denotes a core cutter including a shank portion 2 that is provided at a base end portion thereof and is attached to a chuck of a rotating machine (e.g., desk electric drilling machine), and a cylindrical core body 4 that is provided at a tip end side integrally with the shank portion 2. An enlarged-diameter portion (thick wall portion) 4D is formed at a tip end portion of the core body 4 and has an outer diameter that is made larger than that of a base end portion of the core body 4. A plurality of (in this embodiment, six) cutting chips 1 (1A to 1F) are disposed on a tip end surface of the core body 4, i.e., a tip end surface (bottom surface) of the enlarged-diameter portion (thick wall portion) 4D of the core body 4 so as to have a gap between adjacent cutting chips 1 at suitable intervals in a circumferential direction (i.e., the cutting chips 1 are not continuous). As shown in FIG. 1, the cutting chips 1 are implanted in the core body 4 in such a manner that their cutting blade portions protrude radially outward and inward, and downward in FIG. 4 (see FIGS. 1 and 4). The cutting chips 1 are implanted integrally in the core body 4 by brazing. In this embodiment, three cutting blades 1a, 1b, and 1c extend radially from outward to inward in this order to deviate from each other forward by a predetermined dimension (see arrow R showing a rotational direction in FIGS. 1 and 3). The outer peripheral end portion of the outermost cutting blade 1a has an inclined surface tilted toward the base end of the core cutter A.

As shown in FIG. 1, in the cutting chips 1, inner diameter ends of the cutting chips 1A, 1B, and 1C arranged adjacent to each other in the circumferential direction protrude radially inward farther than the inner diameter ends of the cutting chips 1D, 1E, and 1F. The difference in inward protruding length between the cutting chips 1A, 1B, and 1C and the cutting chips 1D, 1E, and 1F is represented by t, and the whole radial width of the cutting chips 1A, 1B, and 1C is represented by W (see FIG. 1). To be specific, when the core cutter A rotates, the rotational track formed by the inner diameter ends of the three cutting blades 1A, 1B, and 1C is indicated by Tr (diameter Dt), and the inner diameter ends of the cutting blades 1D, 1E, and 1F are located radially outward relative to the rotational track Tr.

Therefore, when the core cutter A rotates in a predetermined rotational direction R (see FIG. 1), only the inner diameter ends of the cutting chips 1A, 1B, and 1C disposed to protrude radially inward cut the material to generate cylindrical debris 6 (see a hatched circle in FIG. 2A) remaining at the center region of the core cutter A. The outer diameter ends of the six cutting chips 1 protrude radially outward farther than the outer peripheral surface of the core body 4 and are located at radially the same position. So, when the core cutter A rotates in the predetermined rotational direction R (see FIG. 1), the outer diameter ends of the cutting chips 1A to 1F draw the same rotational track (see FIG. 1), but may alternatively be located to draw the rotational track that radially deviates.

As shown in an enlarged view of FIG. 3, the cutting chip 1 is constructed in such a manner that an inner diameter end 1p of a rear end portion 1g in a rotational direction R is located radially outward relative to an inner diameter end 1p of a front end portion 1k in the rotational direction R, and an outer diameter end 1q of the rear end portion 1g is located radially inward relative to an outer diameter end 1q of the front end portion 1k. To inhibit the rear end portion 1g from interfering with, i.e., being resistant to cutting being performed by the front end portion 1k, an outer edge portion at a front end portion in the rotational direction R protrudes to be located at radially outermost position and an inner edge portion of the front end portion in the rotational direction R protrudes to be located at radially innermost position. These form a so-called relief (relief of a relief angle). In FIG. 3, the ranges (1k) and (1g) in the rotational direction of the front end portion 1k and the rear end portion 1g are indicated by auxiliary lines and arrows.

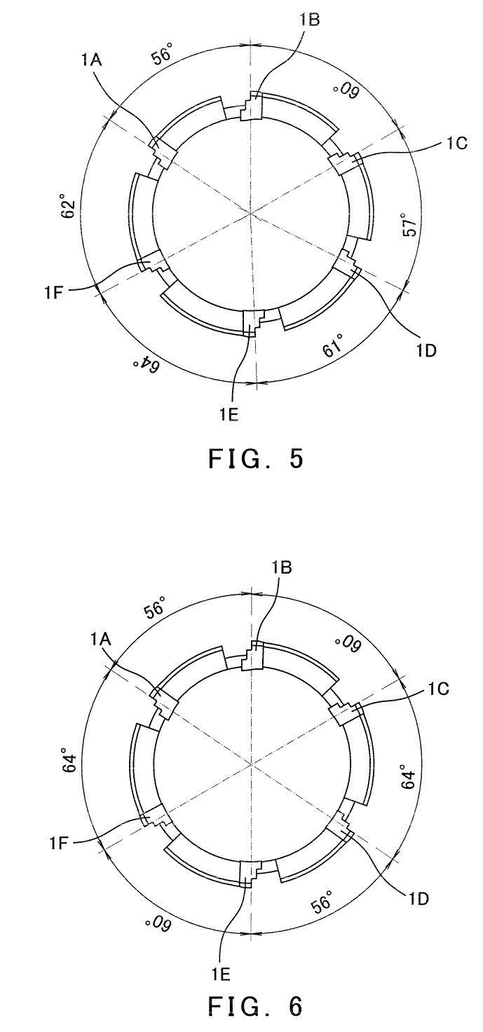

As illustrated in FIG. 5 describing specific angles, the plurality of cutting chips 1A to 1F are arranged at unequal intervals. In this embodiment, 56 degrees are formed between the cutting chips 1A and 1B, 60 degrees are formed between the cutting chips 1B and 1C, 57 degrees are formed between the cutting chips 1C and 1D, 61 degrees are formed between the cutting chips 1D and 1E, 64 degrees are formed between the cutting chips 1E and 1F, and 62 degrees are formed between the cutting chips 1F and 1A. The numeric values of these angles are not limited to these, but may be suitably altered. For example, in another alternative, as shown in FIG. 6, 56 degrees may be formed between the cutting chips 1A and 1B, 60 degrees may be formed between the cutting chips 1B and 1C, 64 degrees may be formed between the cutting chips 1C and 1D, 56 degrees may be formed between the cutting chips 1D and 1E, 60 degrees may be formed between the cutting chip 1E and the cutting chip 1F, and 64 degrees may be formed between the cutting chips 1F and 1A. Instead of different numeric values, two types of numeric values may be alternately arranged, or three types of numeric values may be regularly arranged. In the present invention, the unequal intervals are meant to include these arrangement.

As shown in FIG. 4, in the core cutter A, the cutting chips 1 are disposed at a tip end surface (bottom surface) 4B of the core body 4, and discharge grooves 3 are formed forward of the cutting chips 1 in the rotational direction R and adjacent them to discharge the debris chips so that the debris chips generated by cutting by the cutting chips 1 can be smoothly discharged toward the base end of the core cutter A. The base end of each discharge groove 3 has an inclination angle α that deviates rearward in the rotational direction at the base end side.

As shown in FIG. 4, each cutting chip 1 is implanted in the core body 4 in such a manner that its tip end (lower end) protrudes from the tip end of the core body 4 by a predetermined dimension y downward in FIG. 4. In other words, each cutting chip 1 is configured not to cut into the material to the predetermined dimension y or more. That is, the cutting chip 1 is configured not to cut into the material to the predetermined dimension y or more with the material in contact with the bottom surface 4B of the core body 4 when the cutting chip 1 is cutting the material.

The core cutter A of this embodiment constructed above operates as follows when it is cutting the material. Since the inner ends of the cutting chips 1A to 1C arranged adjacent each other in the circumferential direction protrude radially inward farther than the inner ends of the cutting chips 1D to 1F, cylindrical debris having an outer diameter much smaller than the inner diameter of the core body 4 remain inside the core body 4 by the cutting. Since the outer diameter of the cylindrical debris 6 is much smaller than the inner diameter of the core body 4, there is formed a sufficient gap d (see FIG. 2A) between them, and therefore the cylindrical debris 6 are easily discharged from the inside of the core cutter A when the cutting finishes. In brief, the debris 6 fall off naturally. In contrast, in the conventional core cutter A1, as shown in FIG. 2B, cylindrical debris 106 are substantially in contact with the inner diameter ends of the cutting chips 101 of the core body of the core cutter, and therefore it is difficult to take out those cylindrical debris from the core cutter A.

Furthermore, as described above, the inner diameter end 1p of the rear end portion 1g in the rotational direction R is located radially outward relative to the inner diameter end 1p of the front end portion 1k in the rotational direction R, and the outer diameter end 1q of the rear end portion 1g is located radially inward relative to the outer diameter end 1q of the front end portion 1k, thereby forming a relief. Therefore, the core cutter 1 is able to perform cutting with less cutting resistance and with very high efficiency, i.e., with small rotational torque.

As described above, since the cutting chips 1 are arranged to be unequally spaced apart from each other, a chatter vibration does not occur during the cutting work.

Furthermore, as described above, since the tip end (lower end) of each cutting chip 1 is implanted in the core body 4 to protrude downward from the lower end of the core body 4 by the predetermined protruding length, it does not cut into the material to a large depth during the cutting. As a result, appropriate cutting is possible without a need for a large torque in the drive unit of the rotational tool and the shank portion 2 of the core cutter 1.

### INDUSTRIAL APPLICABILITY

The core cutter of the present invention can be used as the core cutter suitable for cutting materials such as metal or non-metal.

1. A core cutter comprising a core body; cutting chips arranged to be suitably spaced apart from each other in a circumferential direction thereof on a tip end of the core body and a shank portion provided at a base end of the core body;
wherein a plurality of cutting chips arranged adjacent each other in the circumferential direction, which are included in the cutting chips arranged to be suitably spaced apart from each other, protrude radially inward farther than cutting chips other than the plurality of cutting chips arranged adjacent each other.

2. The core cutter according to claim 1, wherein the plurality of cutting chips arranged adjacent each other in the circumferential direction are arranged in a substantially half region of the core body in the circumferential direction.

3. The core cutter according to claim 1, wherein each of the cutting chips is structured in such a manner that an inner diameter end of a rear end portion in a rotational direction of the core cutter is located radially outward relative to an inner diameter end of a front end portion in the rotational direction, and an outer diameter end of the rear end portion is located radially inward relative to an outer diameter end of the front end portion.

4. The core cutter according to claim 1, wherein the plurality of cutting chips arranged to be suitably spaced apart from each other in the circumferential direction are unequally spaced apart from each other.

5. The core cutter according to claim 1, wherein a protruding length of the cutting chip that protrudes downward from the core body is set to a predetermined value or more.
